(19) United States
(12) Patent Application Publication
(10) Pub. No.: US 2010/0116608 A1
(43) Pub. Date: May 13, 2010

(54) SUSPENSION AND DAMPING DEVICE FOR MOTOR VEHICLES

(75) Inventor: Walter RUNKEL, Leubsdorf/Rhein (DE)

Correspondence Address: Brinks Hofer Gilson & Lione/Ann Arbor, 524 South Main Street, Suite 200, Ann Arbor, MI, 48104, US

(73) Assignee: HEMSCHEIDT FAHRWERKTECHNIK GMBH & CO. KG, Hann-Gruitten (DE)

(21) Appl. No.: 12/619,253

(22) Filed: Nov. 16, 2009

Related U.S. Application Data
(63) Continuation-in-part of application No. 11/242,363, filed on Oct. 3, 2005.
(60) Provisional application No. 60/668,773, filed on Apr. 5, 2005.

(30) Foreign Application Priority Data
Apr. 8, 2004 (DE) 20 2004 005 632.2
Nov. 18, 2008 (EP) 08169350.9
Dec. 12, 2008 (EP) 08171551.8

(51) Int. Cl. F16F 9/06

(52) U.S. Cl. 188/314

(57) ABSTRACT

The invention relates to a suspension and damping device (1; 100; 201) for the load-bearing and spring-loaded wheel support and for the damping of suspension movements in a motor vehicle. The device comprises at least one spring cylinder (2; 114; 222) having a piston (6; 118; 226) that is guided in a cylinder (4; 116; 224) such that it can move relative thereto. This piston acts against an elastically compressible spring medium (FM) in order to generate a load-bearing supporting spring force (F), wherein for damping purposes a separate circuit of a hydraulic damping medium (DM) is provided and the circuit is independent of the spring medium (FM). The piston (6; 118; 226) inside the cylinder (4; 116; 224) separates two working chambers (10, 12; 120, 122; 228, 230) from each other, wherein the first working chamber (10; 120; 228) is associated with the spring medium (FM) and the second working chamber (12; 122; 230) is associated with the damping medium (DM). The second working chamber (12; 122; 230) is connected by way of a damper valve arrangement (14; 104; 204) to a hydraulic container (16; 106; 206), in which the damping medium (DM) has a defined initial pressure of 3 to 5 bar, for example.

### CROSS REFERENCE TO RELATED APPLICATION

This application claims priority to European patent applications EP 08169350.9 filed Nov. 18, 2008 and EP 08171551.8 filed Dec. 12, 2008, and is a Continuation-in-Part (CIP) application of and claims priority to U.S. patent application Ser. No. 11/242,363 filed Oct. 3, 2005, which claims priority to German patent application 20 2004 005 632.2 filed Apr. 8, 2004 and U.S. provisional patent application 60/668,773 filed Apr. 6, 2005.

### FIELD OF THE INVENTION

The present invention relates to a suspension and damping device for the load-bearing and spring-loaded wheel support and for the damping of suspension movements in a motor vehicle, comprising at least one spring cylinder having a piston which is guided in a cylinder such that it can move relative thereto and acts against an elastically compressible spring medium in order to generate a load-bearing supporting spring force, wherein for damping a separate circuit of a hydraulic damping medium is provided, the circuit being independent of the spring medium.

### BACKGROUND OF THE INVENTION

WO 03/106202 A1 describes such a suspension device, wherein in some embodiments, a damping device comprises a separate circuit of a hydraulic damping medium, the circuit being independent of the spring cylinder and the spring medium. For this purpose, at least one separate damper cylinder having a damper piston which is guided in a cylinder such that it can move relative thereto and at least one damper valve which is hydraulically connected to the damper cylinder are required. The piston of the spring cylinder is driven by a drive device, which is designed as a gearwheel mechanism and which converts the pivoting movements of a wheel swinging fork supporting arm into the linear relative movements between the cylinder and piston of the spring cylinder. In the process, the damping device having the same drive device and the spring cylinder are to interact, however the media (spring and damping media) are to be completely separated from each other. The reason behind this is that in this way no thermal dependence exists, as a result of which damping-related heating of the damping medium is not critical because the temperature of the spring medium, and therefore also the pressure and the pressure-dependent supporting spring force, remain unaffected thereby. In contrast, heating of the spring medium would also bring about a change in the pressure and consequently in the supporting spring force. The known suspension and damping device, however, has a relatively complex design, which is apparent from the relatively large installation volume and weight.

In addition, conventional telescoping spring cylinders, which often are also referred to as “suspension strut”, are known, which are installed directly between the wheel or wheel swinging fork and the vehicle frame. In the case of a hydropneumatic design of such suspension struts, a hydraulic medium is displaced against a compressible medium, and at the same time this hydraulic flow is also conducted over an integrated damper valve. As a result of the damping effect (restriction), the hydraulic medium however is heated quickly and at times considerably. This heating also affects the compressibility, in particular pneumatic, medium in that the pressure thereof, and consequently the supporting spring force, increase. This results in unfavorable, highly fluctuating suspension and damping properties.

### SUMMARY OF THE INVENTION

The underlying object of the invention is to create a suspension and damping device of the generic type described above, which is characterized by a particularly compact and lightweight design and optimal suspension and damping properties.

According to the invention, this object may be achieved by various embodiments provided herein and described below.

According to at least one embodiment of the invention, the piston inside the cylinder separates two working chambers from each other, wherein the first working chamber is associated with the spring medium and the second working chamber is associated with the damping medium. The spring cylinder according to the embodiment of invention is therefore in principle a kind of suspension strut in the conventional sense, however a hydraulic damping circuit is separated from the spring medium by the piston. The second working chamber is hydraulically connected to a hydraulic container by a damper valve arrangement in that the damping medium has a defined initial pressure, such as 3 to 5 bar. In this way, the flow of the damping medium into the second working chamber is supported (accelerated) during compression of the spring cylinder.

In one embodiment of the invention, at least two suspension and damping devices (damper units) are interconnected into one damping system, wherein at least two damper valves are hydraulically connected to the same, common hydraulic container.

In one aspect, the invention is based on the realization that in a vehicle comprising several damper units not all damper valves are always subject to equal loads, so that also the heating of the damping medium is not uniformly high. Due to the claimed connection of the damper valves to the common hydraulic container, the damping medium can advantageously be exchanged between the individual damper units such that as a result of temperature equalization overall an advantageous reduction in the temperature of the damping medium is achieved. Consequently, the damping medium is continuously exchanged (mixed) between the individual damper units, which overall causes an effective cooling action.

The damping system according to one embodiment of the invention can therefore be employed particularly advantageously in combination with hydropneumatic spring cylinders, wherein each damper unit comprises a telescoping spring cylinder, which includes a piston that is guided in a cylinder such that it can move relative thereto, said piston acting against an elastically compressible spring medium in order to generate a load-bearing supporting spring force. Due to the cooling action, the spring cylinder can be subjected to higher loads, because overall it is heated less. Due to the higher permissible load to which the suspension system can be subjected, the driving performance can be considerably increased, above all also for off-road vehicles.

According to a further aspect of the invention, the hydraulic container comprises a cooling element for dissipating heat of the damping medium to the outside to the surrounding area.

As a result of this embodiment according to the invention, a high percentage of the heat produced by the restriction is dissipated from the damping medium via the cooling element from the hydraulic container to the outside to the surrounding area. Due to this cooling action of the damping medium, heat transfer to a spring medium is also reduced if the damping device is used in combination with a hydropneumatic spring cylinder. Due to this cooling action according to the invention, the spring cylinder can be subjected to higher loads because it is heated less on an overall basis. Due to the higher permissible load to which the suspension system can be subjected, the driving performance can be further increased, above all also for off-road vehicles.

### BRIEF DESCRIPTION OF THE DRAWINGS

The invention will be described below in more detail with reference to several preferred embodiments illustrated in the drawings. The following are shown in schematic, in part axially cut representative illustrations:

FIG. 1 Illustrates a first embodiment of a suspension and damping device according to the invention;

FIG. 2 is a reduced view of the device according to FIG. 1 in a compressed state;

FIG. 3 is a view analogous to FIG. 2 in the extended state;

FIG. 4 is a second embodiment of the device according to the invention in an illustration analogous to FIG. 1;

FIGS. 5 and 6 are illustrations of the embodiment depicted in FIG. 4 respectively in a compressed state and an extended state;

FIG. 7 illustrates illustrations a third embodiment according to the invention;

FIGS. 8 and 9 are illustrations of the embodiment depicted in FIG. 7 respectively in a compressed state and an extended state;

FIG. 10 is another embodiment of a suspension and damping device according to the invention;

FIG. 11 is one embodiment of the invention illustrated by way of the embodiment according to FIGS. 4 to 6;

FIG. 12 is a suspension system for a vehicle comprising, by way of example, three spring cylinders and a damping system according to the invention, all components being shown in the longitudinal sectional view;

FIG. 13 is an enlarged partial view from FIG. 12 of a spring cylinder with the associated damper unit;

FIG. 14 is a further embodiment of the suspension device for a vehicle, comprising a telescoping spring cylinder and a damping device according to the invention, all components being shown in the longitudinal sectional view; and

FIG. 15 is an illustration as in FIG. 14 in a further advantageous embodiment of the invention.

### DETAILED DESCRIPTION

In the different figures of the drawings, in general identical or functionally equivalent parts and components are denoted with the same reference numerals. As a result, any description of a part, which references one or more defined drawing figures, analogously also applies to the other drawing figures in which the part bearing the corresponding reference numeral is likewise shown.

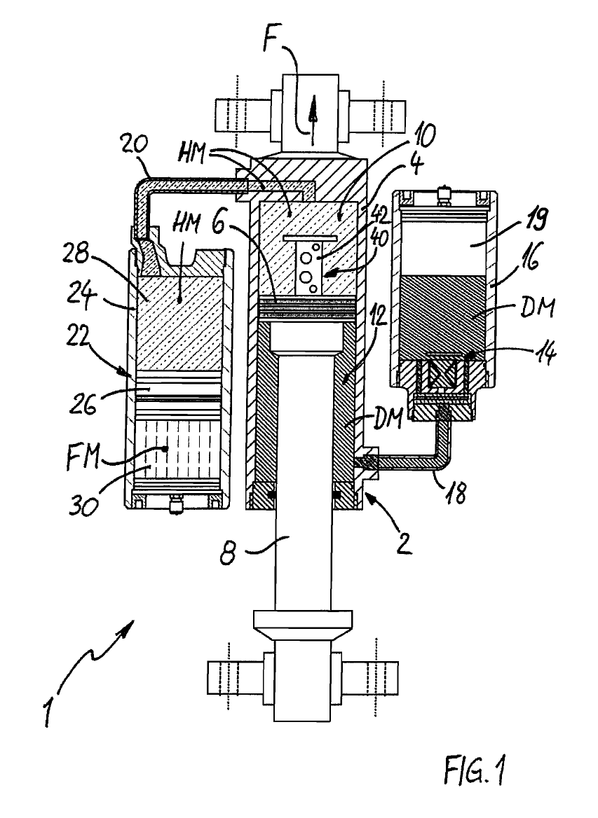

In the exemplary embodiments according to FIGS. 1 to 11, a suspension and damping device 1 according to the invention comprises (at least) one spring cylinder 2, which is provided for direct arrangement between a vehicle wheel or a wheel swinging fork support arm and a vehicle frame (both not shown). The spring cylinder 2 is composed in a telescoping manner of a cylinder 4 and a piston 6 that is guided therein in a linearly displaceable manner, the piston having a piston rod 8, which is led through the cylinder 4 in a peripherally sealed manner.

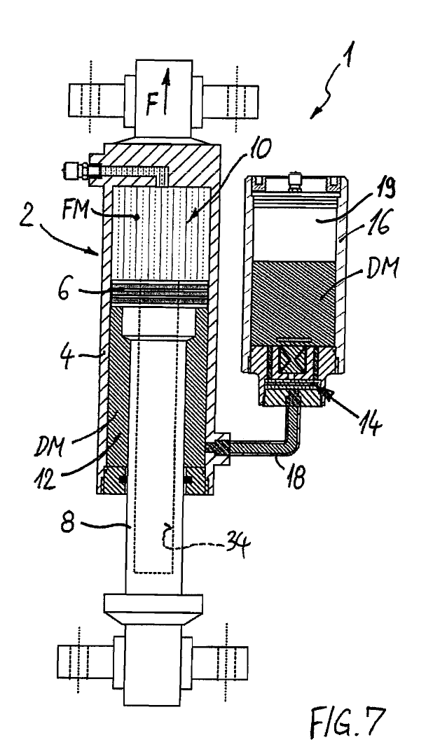

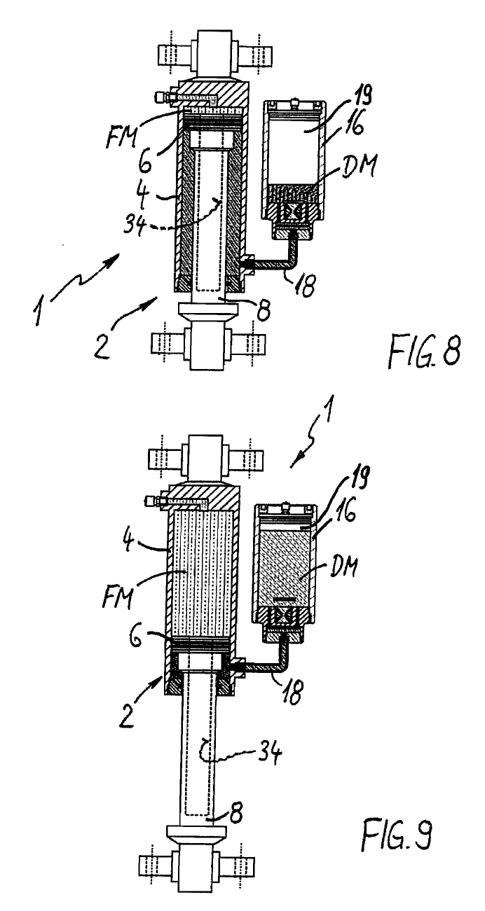

The piston 6 acts indirectly (such as is shown in FIGS. 1 to 6) or directly (such as is shown in FIGS. 7 to 10) against an elastically compressible spring medium FM in order to generate a load-bearing supporting spring force F. A separate circuit of a hydraulic damping medium DM is provided for damping suspension movements, the circuit being independent of the spring medium FM.

The piston 6 rests against the inside surface of the cylinder 4 by way of at least one annular piston seal. In this way, the piston 6 separates two working chambers from each other inside the cylinder 4, wherein a first working chamber 10 is associated with the spring medium FM and a second working chamber 12 is associated with the damping medium DM. The piston 6 according to the invention consequently also separates a “spring circuit” from a “damping circuit”.

In the preferred embodiment shown, the spring cylinder 2 is configured as a pressure cylinder. This means that it basically acts as a compression spring in order to support the respective load. For this purpose, the first working chamber 10 associated with the spring medium FM is formed as a cylindrical space on the side of the piston 6 opposite of the piston rod 8. The second working chamber 12 encloses the piston rod 8 in an annular or hollow-cylindrical manner. Since the second working chamber 12 according to the invention is associated with the damping medium DM, in this embodiment the piston rod 8 advantageously acts as a cooling element for cooling the damping medium DM heating during damping or restriction.

The second working chamber 12 is connected to a hydraulic container 16 by way of a damper valve arrangement 14. The damper valve arrangement 14 is preferably integrated in an inlet region of the hydraulic container 16. The hydraulic container 16 is preferably disposed externally as a separate component, separate from the spring cylinder 2, and connected by a line 18 to the second working chamber 12 of the spring cylinder 2. As the damper valve arrangement 14 is integrated in the inlet region of the hydraulic container 16, damping or restriction related heating of the damping medium DM advantageously takes places in a region that is removed from the spring cylinder 2, and consequently removed from the spring medium FM. In addition, as a result of the external hydraulic container 16, advantageously also an additional cooling effect for cooling the damping medium DM is achieved in that heat is dissipated to the surrounding area via a large outer surface (cooling surface). While a portion of the heat may also reach the second working chamber 12 by way of the damping medium DM, the piston rod 8, as was already indicated above, acts as a cooling element in that it is surrounded by the damping medium DM, thereby transporting the heat thereof to the outside. This is particularly effective because during the suspension movements the piston rod also in part moves to the outside out of the cylinder 4 and can dissipate heat there to the surrounding area. The piston rod 8 acts as or forms a kind of “heat pump”. In addition, heat is also dissipated via the outer surface of the cylinder 4 to the surrounding area. In this way, due to the arrangement according to the invention, overall very large cooling surfaces are used for effective cooling of the damping medium DM such that heat transfer via the piston 6 to the spring medium is advantageously minimal at best.

Additionally, in the preferred embodiments, damping takes place only in half the suspension cycle, specifically through a corresponding design of the damper valve arrangement 14 (comprising throttle and check valves) only during extension, while compression movements are nearly undamped, so that heat can only be produced during extension. The compression stroke can be used for cooling. During compression, hydraulic damping can be foregone because the spring medium FM has almost a damping effect due to an ascending spring characteristic curve.

The hydraulic container 16 is preferably disposed in a vehicle such that it is disposed approximately parallel next to the spring cylinder 2, specifically such that the damping medium DM is located in the lower region due to gravity. Air may be provided in a space 19 above the damping medium DM. According to at least one embodiment of the invention, this space 19 above the damping medium DM should be pressurized to a defined initial pressure, such as 3 to 5 bar, in order to support (accelerate) the flow into the second working chamber during compression.

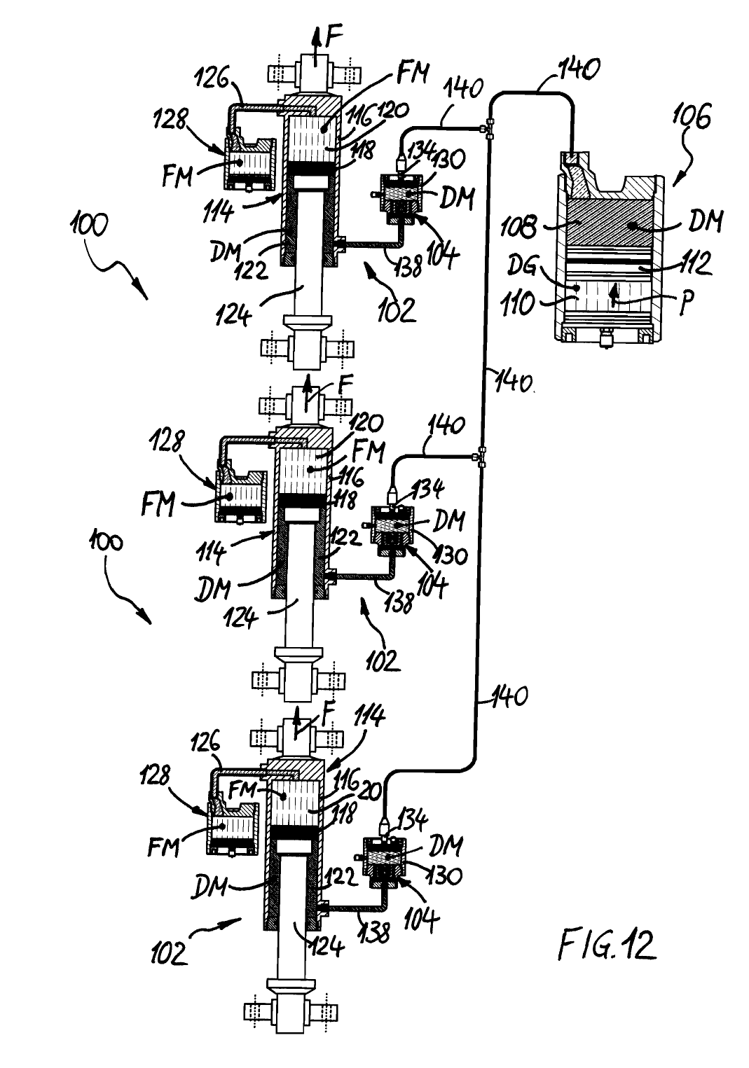

In the embodiments according to FIGS. 1 to 6, and also according to FIG. 11, the first working chamber 10 is connected by a line 20 to a spring accumulator 22 containing the elastically compressible spring medium FM. This spring accumulator 22 is preferably designed as a hydropneumatic piston-type accumulator comprising a dividing piston 26 that is freely movable (floating) in an accumulator cylinder 24. The dividing piston 26 rests against the inner surface of the accumulator cylinder 24 in a sealing manner by way of at least one sealing ring, thereby hydraulically separating an accumulator chamber 28, which is connected by the line 20 to the first working chamber 10, from a spring chamber 30, which contains the spring medium FM, wherein the first working chamber 10 and the spring chamber 28 are filled completely with a hydraulic medium HM. In this way, the piston 6 of the spring cylinder 2 acts directly against the spring medium FM inside the spring chamber 30 by way of the hydraulic medium HM and the dividing piston 26.

During compression, a defined volume of the hydraulic medium HM is displaced by the piston 6 into the accumulator chamber 28, thereby displacing the dividing piston 26 against the spring medium FM in the direction of the spring chamber 30. The resulting volume reduction increases the pressure of the spring medium FM and consequently also the supporting force F.

In the embodiment according to FIGS. 1 to 3, the dividing piston 26 is disposed as a dividing wall completely inside the accumulator cylinder 24. As a result, it must have a relatively large axial length in order to prevent it from tilting inside the accumulator cylinder 24 and thereby becoming jammed (referred to as “drawer effect”).

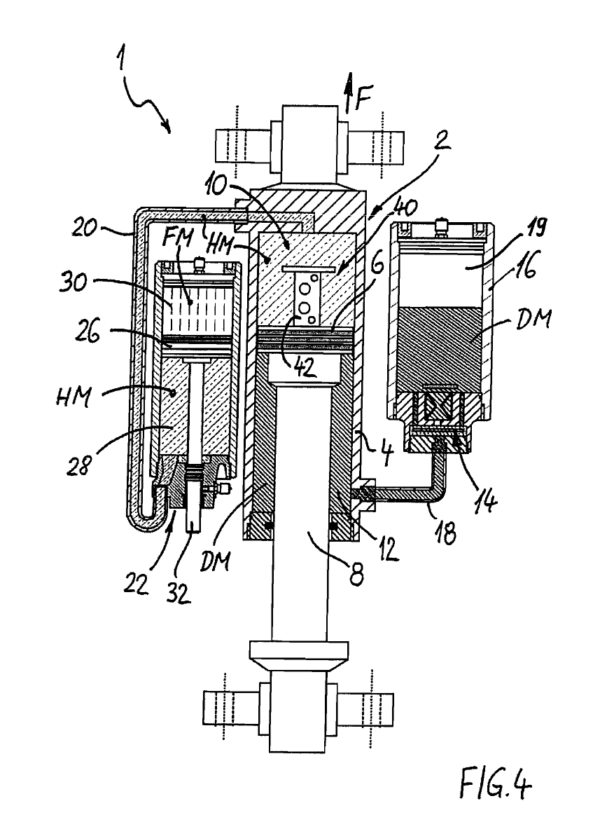

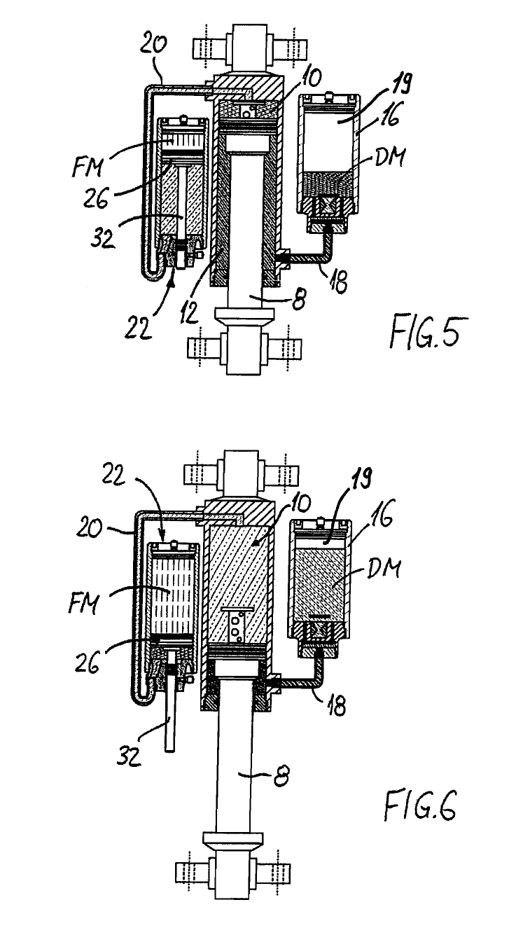

In contrast, according to the embodiment shown in FIGS. 4 to 6 the dividing piston 26 comprises a dividing piston rod 32, which extends axially through the accumulator chamber 28 and is led through the accumulator cylinder 24 to the outside in a sealed manner. The dividing piston rod 32 achieves additional guidance of the dividing piston 26 to prevent tilting such that the dividing piston 26 can be designed to have a shorter axial length. In this way, the overall length of the spring accumulator 22 can be reduced. In addition, due to the dividing piston rod 32, the spring accumulator 22 in this design also acts as a pressure converter such that the pressure of the spring medium FM is always smaller than the pressure of the hydraulic medium HM. This is due to the fact that the pressurized opposing surfaces of the dividing piston 26 are different in size. On the side of the spring chamber 30, the spring medium FM acts on a larger surface, so that a lower pressure of the spring medium FM suffices for a static equilibrium of the dividing piston 26. In other words, due to the smaller annular surface of the dividing piston 26 that encloses the dividing piston rod 32, the opposing pressure of the hydraulic medium HM must be larger in order to keep the dividing piston 26 in equilibrium.

It is further shown in FIGS. 4 to 6, and also in FIG. 11, the spring accumulator 22 is preferably disposed parallel next to the spring cylinder 2, specifically in an orientation in which the piston rod 8 of the spring cylinder 2 and the dividing piston rod 32 of the spring accumulator 22 point in the same direction with respectively equivalent directions of movement. As is apparent from the illustrations in FIGS. 5 and 6, the dividing piston rod 32 moves out of the spring accumulator 22 when the spring cylinder 2 also extends, which is to say when the piston rod 8 likewise moves out of the cylinder 4. In this way, problems regarding collisions with other vehicle components during the vehicle suspension movements are avoided.

In the embodiment according to FIGS. 7 to 9, the first working chamber 10 of the spring cylinder 2 is filled directly with the elastically compressible spring medium FM such that the piston 6 acts directly against the spring medium FM. As a result, an additional, external spring accumulator 22 can be foregone. This produces a particularly compact and lightweight design of the suspension and damping device 1. However, since the compressible spring medium FM cannot be compressed arbitrarily, and in particular not to a volume of zero, in this embodiment a minimum residual volume is formed by the hollow space 34 inside the piston 6 and the piston rod 8.

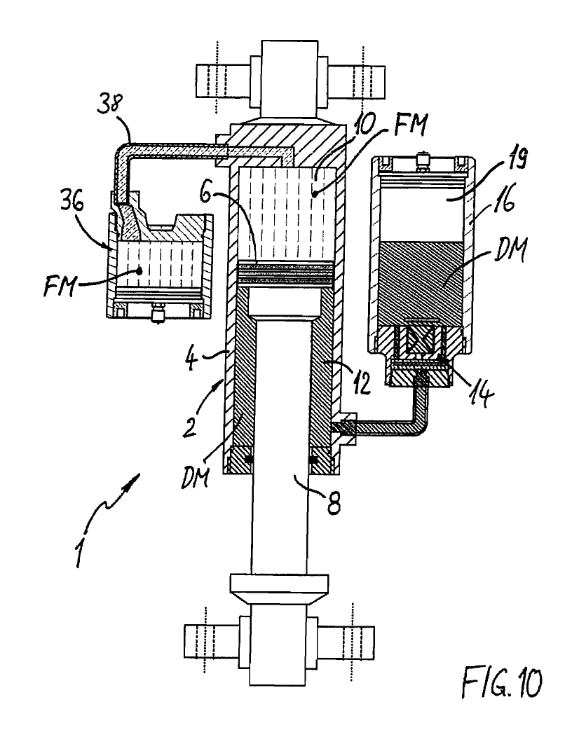

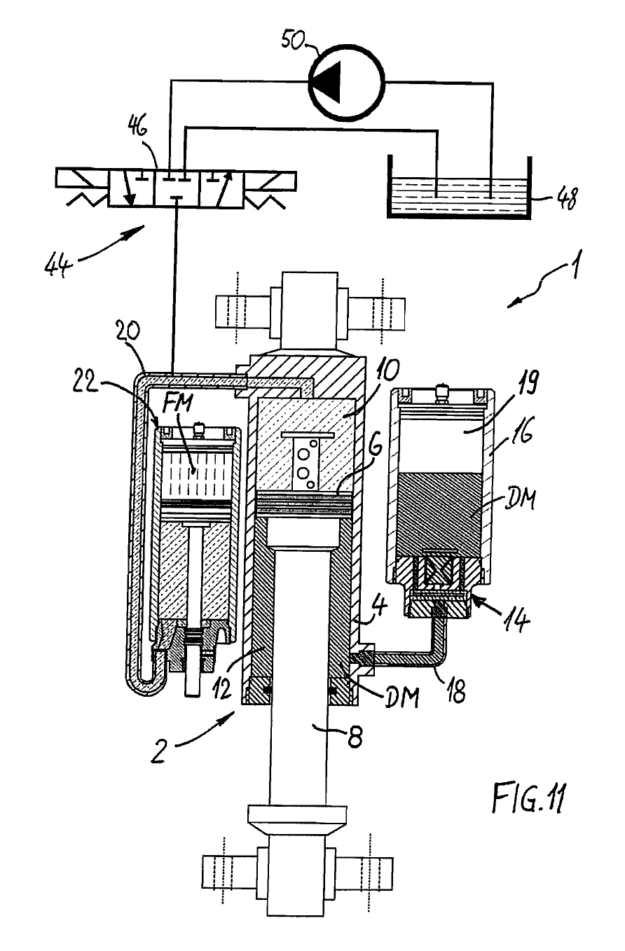

As an alternative to, or in addition to the hollow space 34, according to FIG. 10 an external additional container 36 may be connected by a line 38 to the first working chamber 10. In this design too, the elastic spring medium FM is provided directly in the first working chamber 10.

In particular a gaseous medium, such as nitrogen, can be used as the compressible spring medium FM. As an alternative, any arbitrary other medium, such as a liquid or paste-like (high-viscosity) medium, is suited. A conventional, in particular a low-viscosity hydraulic oil can be used as the damping medium DM and/or hydraulic medium HM.

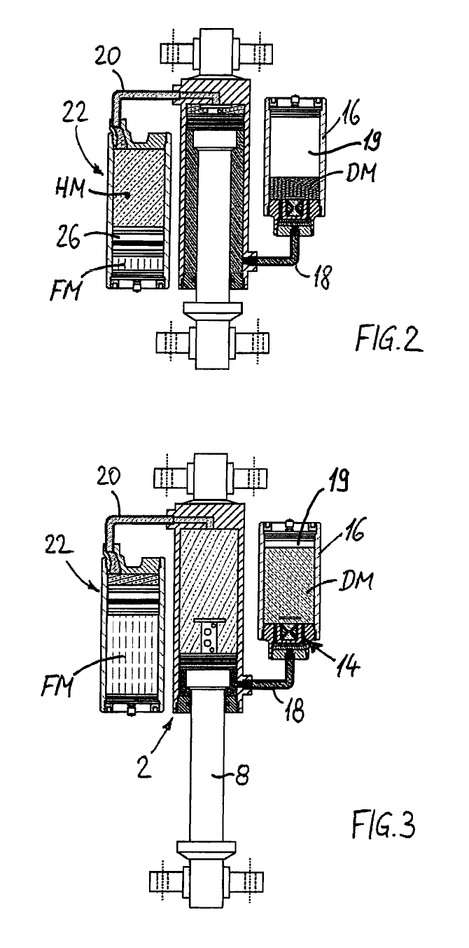

It is also apparent from FIGS. 1 to 6 that the spring cylinder 2 is preferably equipped with a device for hydraulic end-of-stroke damping. This end-of-stroke damping is denoted in FIGS. 1 and 4 with reference numeral 40. This end-of-stroke damping 40 in the compression direction preferably ensures a slowing of the suspension movements toward an end of the compression stroke before a mechanical limit stop is reached. Specifically, it is a path-dependent hydraulic throttling device comprising a tappet 42 which can be disposed in the piston 6 in a telescoping manner and comprises an axial flow channel, into which a plurality of radial transverse openings flow, which are distributed over the length. By lowering the tappet 42 into the piston 6, the transverse openings are successively closed during the movement to the limit stop position. In this way, the flow resistance is successively increased because, when the tappet 42 has mechanical contact in the region of an outlet opening of the cylinder 4 (see the positions in FIGS. 2 and 5), the hydraulic medium HM can flow out only via the transverse openings and the axial channel of the tappet 42. In this way, the respective movement is gently slowed, and hard contact with the limit stop is advantageously avoided.

FIG. 11 illustrates a hydraulic leveling device 44, which is designed such that a static vehicle level can be varied by feeding hydraulic medium HM to or draining it from the spring circuit. For this purpose, the leveling device 44 comprises a control valve 46, a tank 48, and a pump 50. The control valve 46 is designed as a 3/3 way valve and is closed in the position shown. In a first control position, the pump 50 can be connected to the suspension circuit in order to feed hydraulic medium, thereby raising the level. In a second control position, the suspension circuit is connected to the tank 48 in order to drain hydraulic medium so as to lower the level.

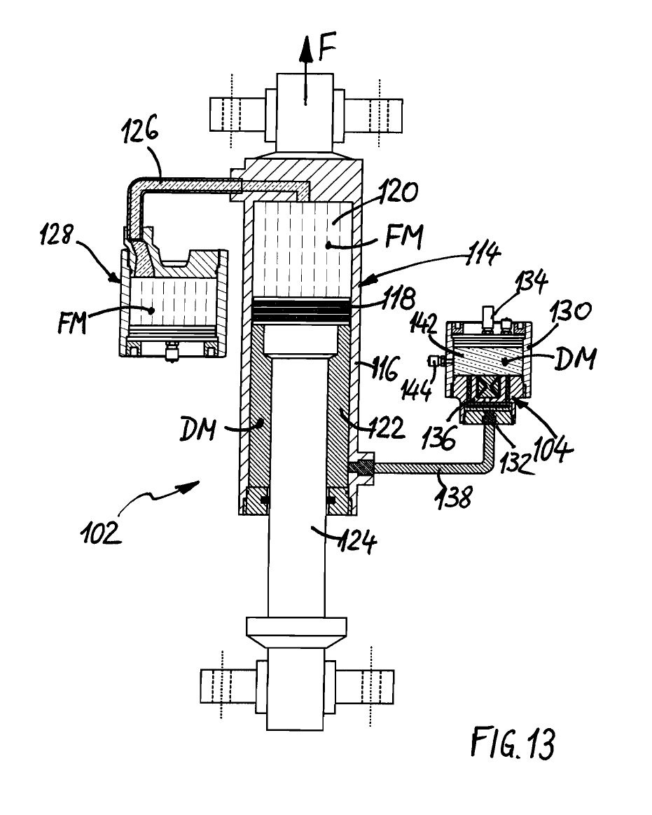

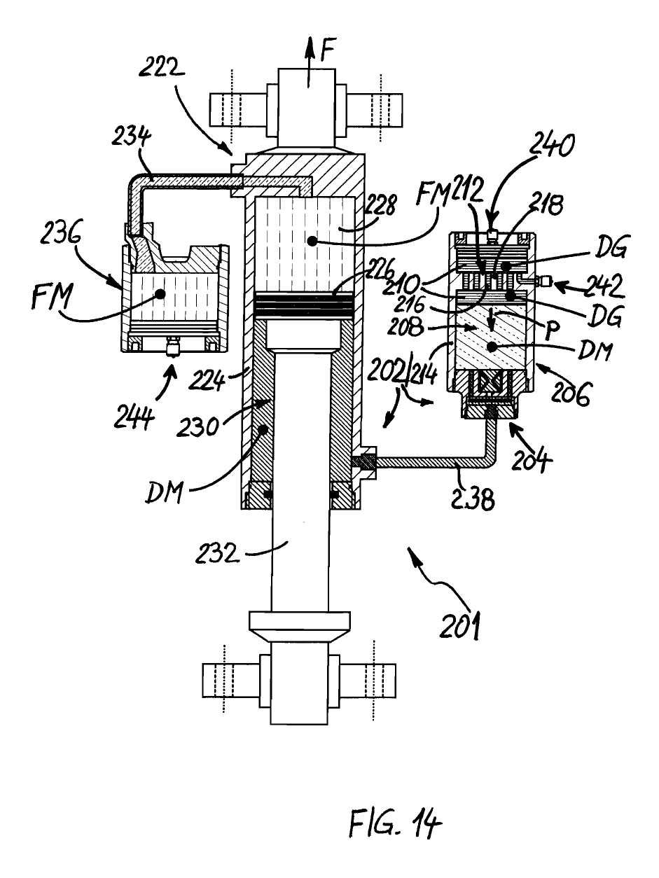

Below, the special embodiment according to FIGS. 12 and 13 are explained.

As is first apparent from FIG. 12, a damping system 100 according to one embodiment of the invention is shown, which comprises at least two damper units 102 for damping wheel suspension movements inside a vehicle. In general, in a wheeled vehicle each wheel is equipped with a dedicated damper unit 102 such that a four wheel vehicle comprises four damper units 102, even if in FIG. 12 only three damper units 102 are shown by way of example. Each damper unit 102 has a hydraulic damper valve 104 for restricting flows of a hydraulic damping medium DM, which are caused by suspension movements.

According to the invention, at least two, preferably all, damper valves 104 present in the damping system are hydraulically connected to a common hydraulic accumulator container 106. For this purpose, this hydraulic container 106 comprises an accumulator chamber 108 for volume portions of the damping medium DM, which vary during the damping of the suspension movements. The damping medium DM present in the accumulator chamber 108 is preferably pressurized to an initial pressure p. In a preferred embodiment, the hydraulic container 106 for this purpose comprises a pressure chamber 110 adjacent to the accumulator chamber 108, wherein the pressure chamber comprises a compressed gas DG pressurizing the damping medium DM to the initial pressure p. The initial pressure p of the compressed gas DG may range between 2 and 20 bar, particularly between 3 and 10 bar. This initial pressure p supports the respective return flow of the damping medium DM out of the accumulator chamber 108 back via the respective damper valve 104. It is further advantageous for the accumulator chamber 108 to be separated from the pressure chamber 110 by a dividing element in a media-tight manner. In the illustrated example according to FIG. 12, a dividing piston 112 which is guided in a freely movable (floating) manner is disposed as the dividing element inside the cylindrical hydraulic container 106. Due to the dividing element, the hydraulic container 106 can advantageously be disposed in any arbitrary spatial orientation, for example as is shown in FIG. 12 such that the accumulator chamber 108 is disposed “at the top” and the pressure chamber 110 “at the bottom”.

At this point, it should be noted that the hydraulic container 106 serves exclusively as a reservoir for the damping medium DM flowing back and forth for damping purposes. This means that the hydraulic container 106 is exclusively associated with the damping circuit and consequently has no spring effect for wheel support in the vehicle.

In a further advantageous embodiment, however, the damping system is basically combined with a suspension system. For this purpose, each damper unit 102 is preferably part of a telescoping spring cylinder 114, which is provided between a vehicle wheel or a wheel suspension and a vehicle frame (not shown) particularly for arrangement as a suspension strut. Each spring cylinder 114 comprises a cylinder 116 and a piston 118 which is guided therein such that it can carry out linear relative movements thereto, the piston acting against an elastically compressible spring medium FM in order to generate a load-bearing supporting spring force F. At each spring cylinder 114, the piston 118 separates two working chambers 120 and 122 from each other inside the cylinder 116 in a media-tight manner; the first working chamber 120 is associated with the spring medium FM, while the second working chamber 122 is associated with the hydraulic damping medium DM. In this way, two circuits of the spring medium FM for suspension and of the damping medium DM for damping are created, which are independent of each other. In this way, largely thermal independence between the media DM and FM is achieved. On the piston side, the piston 118 is connected to a piston rod 124, which is led through the cylinder 116 to the outside in a peripherally sealed manner. As a result, one of the two working chambers is designed as an annular chamber enclosing the piston rod 124.

In the illustrated preferred embodiment, the annular chamber enclosing the piston rod 124 forms the second working chamber 112 associated with the damping medium DM, while an opposing cylinder chamber forms the first working chamber 120 associated with the spring medium FM.

The first working chamber 120 is filled with the elastically compressible spring medium FM and is connected in particular by a line 126 to an additional spring accumulator 128, which is likewise filled with spring medium FM. The spring medium FM is pressurized to an accordingly high pressure level in order to generate the supporting spring force F by applying pressure to the piston 118.

As an alternative to this embodiment, it is also possible to fill the first working chamber 120 with a hydraulic medium and connect it hydraulically to the spring accumulator 128, wherein the spring accumulator 128 can then be designed as a hydropneumatic accumulator, for example comprising a dividing piston between the hydraulic medium and the spring medium.

The second working chamber 122 is filled with the hydraulic damping medium DM and connected to the associated damper valve 104. The damper valve 104 can be disposed on the outside or inside of the associated spring cylinder 114 (not shown). In the illustrated advantageous embodiment, however, each damper valve 104 is designed as a separate component having a dedicated valve housing 130 to be disposed away from the spring cylinder 114. For this purpose, reference is made in particular to the enlarged illustration in FIG. 13. According to this illustration, the valve housing 130 comprises an input connection 132 to be connected to the spring cylinder 114 and an output connection 134 to be connected to the hydraulic cylinder 106. Inside the valve housing 130, a throttle valve arrangement 136 is disposed between the input connection 132 and the output connection 134. The input connection 132 of each damper valve 104 is connected to the associated spring cylinder 114, specifically to the second working chamber 122 thereof, by way of a hydraulic line 138. The output connections 134 of all damper valves 104 are connected to the common hydraulic container 106 by way of hydraulic lines 140 (see FIG. 12).

At least the respective hydraulic line 140 leading to the common hydraulic container 106 can be detachably connected to the damper valve 104 by way of a hydraulic coupling (plug connection). Each damper valve 104 is thus a hydraulically closed system that is completely filled with damping medium DM. The throttle valve arrangement 136 is disposed in the vicinity of the input connection 132, so that a receiving chamber 142 for a defined, but relatively low volume of the damping medium DM is produced between the throttle valve arrangement 136 and the output connection 134. The damping medium DM can be filled into the receiving chamber 142 via a filling connection 144, and as a result, into the second working chamber 122 of the spring cylinder 114 via the throttle valve arrangement 136 and the hydraulic line 138.

Each throttle valve arrangement 136 comprises two partial valves, specifically a first partial valve having a relatively higher throttling resistance for the flow of the damping medium DM into the hydraulic container 106 and a second partial valve having a relatively lower throttling resistance for the reverse flow out of the hydraulic container 106 back into the spring cylinder 114. In this way, it is achieved that the compression of the spring cylinder 114 is damped little, while the extension is damped more strongly.

In particularly nitrogen is used as the compressed gas DG for the hydraulic container 106 and/or as the spring medium FM for the spring cylinder 114 and/or optionally for the additional spring accumulator 128.

Through the preferably external arrangement of each damper valve 104, separate from the respective spring cylinder 114, and in particular through the connection according to the invention of the damper valves 104 to the common hydraulic container 106, very effective cooling of the damping medium DM heating during throttling is achieved. In this way, heat transmission inside the respective spring cylinder 114 to the spring medium FM is kept extraordinarily low such that the spring system equipped with the damping system according to the embodiment of the invention ensures very consistent suspension and damping properties.

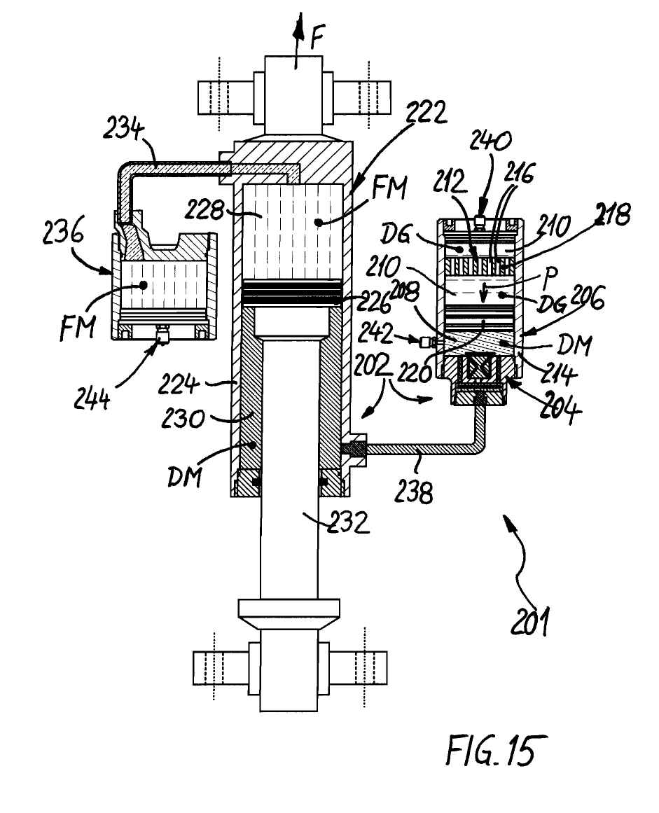

The embodiment according to FIGS. 14 and 15 will now be described.

As is first apparent from FIG. 14, a damping device 201 according to one embodiment of the invention comprises at least one damper unit 202 for damping wheel suspension movements inside a vehicle. In general, in a wheeled vehicle each wheel is equipped with a dedicated damper unit 202 such that a four wheel vehicle comprises four damper units 202. The damper unit 202 has a hydraulic damper valve 204 for reducing flows of a hydraulic damping medium DM caused by suspension movements. A hydraulic container 206 is connected downstream of the damper valve 204, which is to say it is connected hydraulically downstream thereof.

This hydraulic container 206 comprises an accumulator chamber 208 for volume portions of the damping medium DM, which vary during the damping of the suspension movements. The damping medium DM present in the accumulator chamber 208 is preferably pressurized to an initial pressure p. In a preferred embodiment, the hydraulic container 206 for this purpose comprises a pressure chamber 210 adjacent to the accumulator chamber 208, wherein the pressure chamber comprises a compressed gas DG pressurizing the damping medium DM to the initial pressure p. The initial pressure p of the compressed gas DG may range between 2 and 20 bar, particularly between 3 and 10 bar. This initial pressure p supports the respective return flow of the damping medium DM out of the accumulator chamber 208 back via the respective damper valve 204.

According to at least one embodiment of the invention, the hydraulic container 206 from FIGS. 14 and 15 comprises a cooling element 212 for removing heat of the damping medium DM to the outside to the surrounding area. In a preferred embodiment, the cooling element 212 is formed by an intermediate wall 218, which is disposed inside an in particular cylindrical housing 214 of the housing container 206 and comprises a plurality of continuous flow openings 216. This intermediate wall 218, and also the housing 214, are each made of a material having good thermal conductivity, in particular metal, and are connected to each other in a heat-conducting manner. In this way, heat produced by restricting (internal molecular friction) the damping medium DM is dissipated from the interior of the hydraulic container 6 via the cooling element 212 or the intermediate wall 218 to the housing 214 and then emitted to the outside to the surrounding area via the outer surface of the housing 214.

In the first embodiment according to FIG. 14, the compressed gas DG is directly applied to damping medium DM. The hydraulic container 206 must be oriented in the space such that the accumulator chamber 208 is disposed vertically at the bottom and the pressure chamber 210 at the top. In this design, the intermediate wall 218 can be disposed arbitrarily in the region of the accumulator chamber 208 and/or in the region of the pressure chamber 210 (depending on the fill level of the accumulator chamber 208). The damping medium DM and/or the compressed gas DG thus flow through the flow openings 216 of the intermediate wall 218 with respect to the suspension-related flows of the damping medium DM. In the preferred embodiment shown in FIG. 14, the intermediate wall 218, regardless of the fill level of the accumulator chamber 208, is always disposed inside the pressure chamber 10 such that only the compressed gas DG flows through the flow openings 216. In the process, the heat is transmitted from the damping medium DM via the compressed gas DG into the intermediate wall 218 and dissipated from there to the outside to the housing 214.

In the embodiment according to FIG. 15, the accumulator chamber 208 is separated in a media-tight manner from the pressure chamber 210 by a dividing element. In the illustrated example, a dividing piston 220 which is guided in a freely movable (floating) manner is disposed as the dividing element inside the cylindrical hydraulic container 206. Due to the dividing element, the hydraulic container 206 can advantageously be disposed in any arbitrary spatial orientation, for example deviating from the illustration shown in FIG. 15, such that the accumulator chamber 208 is disposed “at the top” and the pressure chamber 210 “at the bottom”. In the embodiment according to FIG. 15, the intermediate wall 218 is likewise preferably disposed inside the pressure chamber 210, specifically at such a location that for all suspension-related flows of the damping medium DM occurring in practical applications the ability of the dividing piston 220 to move remains ensured. In this embodiment, the heat produced in the damping medium DM is transmitted via the dividing piston 220 into the compressed gas DG and is then removed via the cooling element 212. As an alternative to this embodiment according to FIG. 15, it is in principle also possible to dispose the intermediate wall 218 inside the accumulator chamber 208.

At this point, it should be noted again that the hydraulic container 206 serves exclusively as a reservoir for the damping medium DM flowing back and forth for damping purposes. This means that the hydraulic container 206 is exclusively associated with the damping circuit and consequently has no spring effect for wheel support in the vehicle.

In a further advantageous embodiment, however, the damping system 201 is basically combined with a suspension system. For this purpose, each damper unit 202 is preferably part of a telescoping spring cylinder 222, which is provided between a vehicle wheel or a wheel suspension and a vehicle frame (not shown) particularly for arrangement as a suspension strut. The spring cylinder 222 comprises a cylinder 224 and a piston 226 guided therein such that it can carry out linear relative movements, the piston acting against the pressure of an elastically compressible spring medium FM in order to generate a load-bearing supporting spring force F. The piston 226 separates two working chambers 228 and 230 from each other inside the cylinder 224 in a media-tight manner. The first working chamber 228 is associated with the spring medium FM, while the second working chamber 230 is associated with the hydraulic damping medium DM. In this way, two circuits of the spring medium FM for the suspension and of the damping medium DM for the damping are created, which are independent of each other. In this way, largely thermal independence between the media DM and FM is achieved. On the piston side, the piston 226 is connected to a piston rod 232, which is led through the cylinder 224 to the outside in a peripherally sealed manner. As a result, one of the two working chambers is designed as an annular chamber enclosing the piston rod 232.

In the illustrated preferred embodiments, the annular chamber enclosing the piston rod 232 forms the second working chamber 230 associated with the damping medium DM, while an opposing cylinder chamber forms the first working chamber 228 associated with the spring medium FM.

The first working chamber 228 is filled with the elastically compressible spring medium FM and in particular is connected by a line 234 to an additional spring accumulator 236, which is likewise filled with spring medium FM. The spring medium FM is pressurized to an accordingly high pressure level in order to generate the supporting spring force F by applying pressure to the piston 226.

As an alternative to this embodiment, it is also possible to fill the first working chamber 228 with a hydraulic medium and connect it hydraulically to the spring accumulator 236, wherein the spring accumulator 236 should then be designed as a hydropneumatic accumulator, for example comprising a dividing piston between the hydraulic medium and the spring medium.

The second working chamber 230 is filled with the hydraulic damping medium DM and is connected to the damper valve 204. The damper valve 204 can be disposed in principle on the outside or inside of the spring cylinder 222 (not shown). In the illustrated, advantageous embodiments, however, the damper valve 204 is designed as a separate component having a dedicated housing 214 disposed away from the spring cylinder 222 and is connected to the spring cylinder 222 by a hydraulic line 238.

The throttle valve 204 in turn comprises two partial valves, specifically a first partial valve having a relatively higher throttling resistance for the flow of the damping medium DM into the hydraulic container 206 and a second partial valve having a relatively lower throttling resistance for the reverse flow out of the hydraulic container 206 back into the spring cylinder 222. In this way, it is achieved that the compression of the spring cylinder 222 is damped little, while the extension is damped more strongly.

In particularly nitrogen is used as the compressed gas DG for the hydraulic container 206 and/or as the spring medium FM for the spring cylinder 222 and/or optionally for the additional spring accumulator 236.

Through the preferably external arrangement of the damper valve 204, separate from the spring cylinder 222, and in particular through the cooling element 212 according to the invention, very effective cooling of the damping medium DM heating during throttling is achieved. In this way, heat transmission inside the respective spring cylinder 222 to the spring medium FM is kept extraordinarily low such that the spring system equipped with the damping system according to the embodiment of the invention ensures very consistent suspension and damping properties.

In a further advantageous embodiment of the invention, the hydraulic container 206 comprises a pressure control valve 240, which is designed in particular such that it opens starting a defined overpressure, which corresponds to the respective maximum value of the initial pressure p. The pressure control valve 240, for example, opens starting at approximately 20 bar, preferably starting at approximately 10 bar. The pressure control valve 240 advantageously prevents the higher pressure of the spring medium FM from causing impermissible overpressure in the hydraulic container 206 in the event of a leak in the region of the seals of the piston 226.

The hydraulic container 206 can furthermore have a filling valve 242 in a suitable location of the housing 214. In addition, the spring accumulator 236 is also equipped with a filling valve 244.

A person skilled in the art will appreciate, the above description is meant as an illustration of the implementation of the principles of this invention. This description is not intended to limit the scope or application of this invention in that the invention is susceptible to modification, variation and change, without departing from the spirit of this invention, as defined in the following claims.

1. A suspension and damping device for a load-bearing and spring-loaded wheel support and for damping of suspension movements in a motor vehicle, the device comprising: at least one spring cylinder having a piston that is guided in a cylinder such that it the piston can move relative thereto, the piston acting against an elastically compressible spring medium (FM) in order to generate a load-bearing supporting spring force (F), a separate circuit of a hydraulic damping medium (DM) being provided for damping, the separate circuit being independent of the spring medium (FM), wherein the piston inside the cylinder separates two working chambers from each other defining a first working chamber and a second working chamber, the first working chamber is associated with the spring medium (FM) and the second working chamber is associated with the damping medium (DM), and the second working chamber is connected via a damper valve arrangement to a hydraulic container in which the damping medium (DM) is pressurized to a defined initial pressure of about 3 to 5 bar.

2. The suspension and damping device according to claim 1, wherein the piston on one side comprises a peripherally sealed piston rod, which is led through the cylinder to the outside such that one of the two working chambers is configured as an annular chamber enclosing the piston rod, wherein the annular chamber forms the second working chamber associated with the hydraulic damping circuit, while an opposing cylinder chamber forms the first working chamber associated with the spring medium (FM).

3. The suspension and damping device according to claim 1, wherein the first working chamber is filled with the elastically compressible spring medium (FM).

4. The suspension and damping device according to claim 1, wherein the first working chamber is connected to a spring accumulator containing the elastically compressible spring medium (FM) by way of a line, wherein the spring accumulator is configured as a hydropneumatic piston-type accumulator having a dividing piston that can move freely in an accumulator cylinder, the dividing piston separates an accumulator chamber which is hydraulically connected to the first working chamber from a spring chamber containing the spring medium (FM), and the first working chamber and the accumulator chamber are filled with a hydraulic medium.

5. The suspension and damping device according to claim 4, wherein the spring accumulator is configured as a pressure converter such that the pressure of the spring medium (FM) is smaller than the pressure of the hydraulic medium (HM).

6. The suspension and damping device according to claim 1, wherein the damper valve arrangement is disposed in an inlet region of the hydraulic container, the hydraulic container is connected to the second working chamber of the spring cylinder via a line, and is disposed parallel next to the spring cylinder, such that the damping medium (DM) is located in a vertically lower region of the hydraulic container due to gravity.

7. The suspension and damping device according to claim 1, further comprising means for end-of-stroke damping of the spring cylinder that acts in the compression direction.

8. The suspension and damping device according to claim 1, further comprising a hydraulic leveling device configured such that a static vehicle level can be varied by feeding hydraulic medium (HM) to or draining the hydraulic medium (HM) from the circuit of the spring medium (FM).

9. The suspension and damping device according to claim 1, wherein at least two damper units interact as a damping system, each of the two damper units comprises a hydraulic damper valve for restricting flows of the hydraulic damping medium (DM), and at least two of the damper valves are hydraulically connected to the same common hydraulic container.

10. The suspension and damping device according to claim 9, wherein adjacent to an accumulator chamber for the damping medium (DM), the hydraulic container comprises a pressure chamber having a compressed gas (DG) applying the initial pressure (p) to the damping medium (DM).

11. The suspension and damping device according to claim 10, wherein the initial pressure (p) is approximately in the range of 2 to 20 bar.

12. The suspension and damping device according to claim 10, wherein the accumulator chamber is separated in a media-tight manner from the pressure chamber via a dividing element that includes dividing piston that is guided such that the dividing piston can move freely.

13. The suspension and damping device according to claim 9, wherein at least one of the damper valves is designed as a separate component having a valve housing with an input connection that is connected to the spring cylinder and an output connection that is connected to the hydraulic container and with a throttle valve arrangement, which is disposed inside the valve housing between the input connection and the output connection.

14. The suspension and damping device according to claim 9, wherein each damper valve comprises two partial valves, including a first partial valve having a higher throttling resistance for the flow of the damping medium (DM) into the hydraulic container and a second partial valve having a lower throttling resistance for the reverse flow out of the hydraulic container.

15. The suspension and damping device according to claim 1, wherein the hydraulic container comprises a cooling element for dissipating heat of the damping medium (DM) to the outside to the surrounding area.

16. The suspension and damping device according to claim 15, wherein the cooling element is formed by an intermediate wall, which is disposed inside a housing of the hydraulic container and comprises flow openings, wherein the intermediate wall and the housing each comprise a material having relatively high thermal conductivity and are connected to each other in a heat-conducting manner.

17. The suspension and damping device according to claim 16, wherein the intermediate wall is disposed in at least one of the region of the accumulator chamber and in the region of the pressure chamber to which the initial pressure (p) is applied.

18. The suspension and damping device according to claim 17, wherein the accumulator chamber is separated in a media-tight manner from the pressure chamber by way of a dividing element that includes a dividing piston that is guided such that it the dividing piston can move freely, wherein the intermediate wall is disposed inside the pressure chamber or inside the accumulator chamber.

19. The suspension and damping device according to claim 15, wherein the hydraulic container comprises a pressure control valve, which is configured such that the pressure control valve opens at an overpressure starting at approximately, 10 bar or higher.
